(19) United States
(12) Patent Application Publication
(10) Pub. No.: US 2013/0139394 A1
(43) Pub. Date: Jun. 6, 2013

(54) HAND-SAW BLADE, HAND-SAW HAVING THE SAME AND METHOD OF MANUFACTURING THE HAND-SAW BLADE

(71) Applicant: Azer Babaev, Moscow (RU)

(72) Inventor: Azer Babaev, Moscow (RU)

(21) Appl. No.: 13/486,494

(22) Filed: Jun. 1, 2012

(30) Foreign Application Priority Data
Sep. 16, 2010 (EP) 10 009 713.8

(51) Int. Cl. B26B 27/00

(52) U.S. Cl. 30/507; 30/355; 30/517

(57) ABSTRACT

A hand-saw-blade having a first edge provided with saw teeth and a plurality of elongated apertures spaced apart in a direction of the first edge is disclosed. A direction of elongation of the elongated apertures is oriented including an angle of between 15° and 65° and especially between 20° and 55° and further especially between 25° and 45° relative to the first edge.

Furthermore, a hand-saw having this hand-saw-blade and a handle or bow-shaped metal-frame is disclosed, wherein the handle is mounted at one edge of the hand-saw-blade other than the first edge respectively ends of the bow-shaped metal-frame are attached to opposing edges of the hand-saw-blade different from the first edge.

### CROSS REFERENCES TO RELATED APPLICATIONS

The present application is related to European Patent Application No 10 009 713.8, filed on Sep. 16, 2010, the disclosure of which is hereby incorporated by reference in its entirety.

### BACKGROUND OF THE INVENTION

Hand-saws using a blade with an abrasive edge to cut through materials that are softer than the blade are used in various fields such as forestry, construction, demolition, medicine, and hunting, to give a few examples. The blade can be made of brass, steel or ceramics, for example. The materials cut by hand-saws are e.g. wood, stone, plastics, or metal.

There are different types of hand-saws:

Handsaws, also known as ‘panel saws’ and ‘fish saws’ consist of a blade and a handle attached to the blade. Often, the blade is oblong, wedge-shaped or even trapezoid-shaped, for example. Teeth are provided along a long edge of the blade while the handle is attached to one short edge of the blade. In case of the wedge- or trapezoid-shaped blade, having two narrow edges, the handle frequently is attached to the wider of the two narrow edges of the blade. A special type of handsaw is a backsaw having a stiffening rib on the edge opposite the cutting edge of the blade.

A bow saw is a saw having a bow-shaped metal-frame and an oblong hard blade clamped between two ends of the metal-frame.

The teeth of the saw can be of different types, such as ‘crosscut’ and ‘rip’, for example. Crosscut teeth are shaped in such a way that they form a series of tiny knifelike edges. Rip teeth are shaped so that they form a series of tiny chisel-like edges. Furthermore, the teeth can be designed in a way that the saw cuts only on the pull stroke, or only on the push stroke, or both on the pull and push stroke. Thus, the blade has a cutting direction, wherein a cutting effect of the blade is greater when it is moved in the cutting direction relative to a material to be cut as compared to a cutting effect of the blade when it is moved in a direction opposite to the cutting direction relative to the material to be cut.

Document U.S. Pat. No. 1,306,165 discloses a handsaw having a blade containing geometrical symbols and cuts for measuring purposes.

Another handsaw having a blade with cuts is disclosed in U.S. Pat. No. 6,886,261. The cuts are teardrop shaped and arranged in a straight line along the length of the blade. Arranging a sidewall of the blade in parallel to a material to be cut in a way that a handle of the blade contacts an edge of the material and inserting the tip of a utility knife into one of the cuts allows guiding the knife in parallel to a handle of the handsaw when the handle is moved along the edge of the material.

It is a disadvantage with known hand-saws to be worked by hand using a blade with an abrasive edge that the efficiency of sawing is unsatisfactory.

### SUMMARY OF THE INVENTION

Embodiments are directed to a hand-saw-blade for a hand-saw providing increased efficiency of sawing. According to an embodiment of the present invention, a hand-saw blade, a hand-saw having the same and a method of manufacturing the hand-saw blade are disclosed.

A hand-saw-blade (1; 1′; 1″; 1′″) having a first edge (2a) provided with saw teeth (31-3n) and a plurality of elongated apertures (41-4m) spaced apart in a direction of the first edge (2a) is disclosed. A direction (Da; Da′) of elongation of the elongated apertures (41-4m) is oriented including an angle (α, α′) of between 15° and 65° and especially between 20° and 55° and further especially between 25° and 45° relative to the first edge (2a).

Furthermore, a hand-saw having this hand-saw-blade (1; 1′; 1″; 1′″) and a handle or bow-shaped metal-frame is disclosed, wherein the handle is mounted at one edge of the hand-saw-blade (1; 1′; 1″; 1′″) other than the first edge (2a) respectively ends of the bow-shaped metal-frame are attached to opposing edges of the hand-saw-blade (1; 1′; 1″; 1′″) different from the first edge (2a).

In this respect, the term “hand-saw” denotes any saw suitable to be worked by hand such as but not limited to handsaws and bow saws. In consequence, a hand-saw-blade is a blade of a saw to be worked by hand in contrast to a blade of a saw powered by steam, water, electricity or other power.

According to an embodiment a hand-saw-blade has a first edge provided with saw teeth and a plurality of elongated apertures spaced apart in a direction of the first edge, wherein a direction of elongation of the elongated apertures is oriented including an angle of between 15° and 65° and especially between 20° and 55° and further especially between 25° and 45° and further especially between 30° and 40° relative to the first edge.

The tilted orientation of the elongated apertures with respect to the first edge causes chips that are produced during sawing and have entered the elongated apertures to be moved away from the teeth. In consequence, the chips are not effected multiple times by the teeth. Furthermore, by removing the chips, friction between the hand-saw-blade and a material to be cut is reduced, preventing sticking of the hand-saw-blade in the material to be cut. Moreover, by providing the apertures, a contact surface between the hand-saw-blade and the material to be cut is lowered, reducing friction between the hand-saw-blade riding along the material to be cut. Further, chips in the cutting area, as well as fibers protruding from the cut material, generate a pressure on an edge of the elongated apertures located opposite to a direction of movement of the hand-saw-blade. Due to the tilted orientation of the elongated apertures this pressure has a component pressing the teeth of the first edge of the hand-saw-blade against the material to be cut. In consequence, provision of the tilted elongated apertures increased sawing efficiency of the hand-saw-blade.

Naturally, it is not excluded that saw teeth are further provided at edges of the hand-saw-blade other than the first edge. For example, saw teeth may further be provided at a second edge opposite to the first edge.

According to an embodiment, a line orthogonal to the first edge intersects two or more elongated apertures. Thus, the elongated apertures can be arranged overlapping each other when seen in a direction from the first edge of the hand-saw-blade. This overlap guarantees a particularly efficient removal of the chips.

According to an embodiment, the hand-saw-blade has a cutting direction oriented along the direction of the first edge, wherein a cutting effect of the hand-saw-blade is greater when it is moved in the cutting direction relative to a material to be cut as compared to a cutting effect of the hand-saw-blade when it is moved in a direction opposite to the cutting direction relative to the material to be cut.

In this case, a first end of the elongated aperture located closer to the first edge may be displaced in the cutting direction relative to a second end of the elongated aperture located closer to a second edge located opposite to the first edge. This guarantees that the hand-saw-blade is pressed against the material when moved in the cutting direction due to pressure generated by chips and fibers in the cutting area on an edge of the elongated apertures located opposite to a direction of movement of the hand-saw-blade.

According to an embodiment a maximum distance between the elongated apertures and the first edge measured orthogonal to the first edge is smaller than 0.5-times and in particular smaller than 0.3-times and further in particular smaller than 0.25-times and further in particular smaller than 0.1-times the length of the elongated apertures measured along the direction of elongation. This maximum distance is measured with respect to the utmost end of the teeth. Thus, the elongated apertures are located close to the first edge.

According to an embodiment, a distance between the elongated apertures and the first edge measured orthogonal to the first edge is larger than 0.5-times and in particular larger than 0.75-times and further in particular larger than 1-time and further in particular larger than 1.25-times the width of the elongated apertures measured in a direction orthogonal to the direction of elongation of the elongated apertures. This guarantees sufficient strength of the first edge having the teeth.

The elongated apertures of a particular hand-saw-blade may all have the same or even different distances between the elongated apertures and the first edge measured orthogonal to the first edge.

According to an embodiment, the hand-saw-blade has a second edge located opposite to the first edge, and a length of the elongated apertures measured along the direction of elongation is greater than 0.1-times and in particular greater than 0.25-times and further in particular greater than 0.5-times and further in particular greater than 0.8-times a maximum distance between the first and second edges. This maximum distance is measured with respect to the utmost end of the teeth. This guarantees that chips of the material to be cut can be sufficiently removed from the first edge and thus the teeth.

According to this embodiment, a length of the elongated apertures measured along the direction of elongation may be smaller than 6-times and in particular smaller than 4-times and further in particular smaller than 2-times and further in particular smaller than 1.5-times a maximum distance between the first and second edges to guarantee that the hand-saw-blade is not weakened too much by the elongated apertures.

According to an embodiment a width of the elongated apertures measured in a direction orthogonal to the direction of elongation of the elongated apertures is smaller than 0.5-times and in particular smaller than 0.3-times and further in particular smaller than 0.2-times and further in particular smaller than 0.1-times the length of the elongated apertures measured along the direction of elongation and/or a width of the elongated apertures measured in a direction orthogonal to the direction of elongation of the elongated apertures is smaller than 10-times and in particular smaller than 8-times and further in particular smaller than 6-times and further in particular smaller than 5-times the thickness of the hand-saw-blade. In this respect, the thickness is understood to be the width of the blade. This width guarantees that the hand-saw-blade is not weakened too much by the elongated apertures.

According to this embodiment, a width of the elongated apertures measured in a direction orthogonal to the direction of elongation of the elongated apertures may be larger than 0.05-times and in particular larger than 0.07-times and further in particular larger than 0.08-times and further in particular larger than 0.09-times the length of the elongated apertures measured along the direction of elongation and/or a width of the elongated apertures measured in a direction orthogonal to the direction of elongation of the elongated apertures may be larger than 1-time and in particular larger than 2-times and further in particular larger than 3-times and further in particular larger than 4-times the thickness of the hand-saw-blade. In this respect, the thickness is understood to be the width of the blade. This width guarantees a good transportation of chips of the cut material.

According to an embodiment the elongated apertures cover more than 1% and in particular more than 5% and further in particular more than 10% and further in particular more than 15% of a total surface of a plane defined by outer edges of the hand-saw-blade. This guarantees that a satisfying increase of sawing efficiency.

According to this embodiment the elongated apertures may cover less than 60% and in particular less than 40% and further in particular less than 30% and further in particular less than 25% of a total surface of a plane defined by outer edges of the hand-saw-blade. This guarantees that the hand-saw-blade is not weakened too much by the elongated apertures.

According to an embodiment, a length of the elongated apertures measured along the direction of elongation is greater than 5 mm and in particular greater than 10 mm and further in particular greater than 20 mm and further in particular greater than 30 mm and/or a width of the elongated apertures measured in a direction orthogonal to the direction of elongation of the elongated apertures is between 15 mm and 1 mm and in particular between 12 mm and 2 mm and further in particular between 9 mm and 3 mm and further in particular between 6 mm and 4 mm.

According to an embodiment more than 5 and in particular more than 10 and further in particular more than 20 elongated apertures are spaced apart and in particular equally spaced apart in a direction of the first edge.

The elongated apertures may have an oblong or curved shape, for example. The elongated apertures of a particular hand-saw-blade may all have the same or even different shapes. Furthermore, the elongated apertures of a particular hand-saw-blade may all have the same or even different sizes.

A hand-saw according to an embodiment has a hand-saw-blade as described above and a handle mounted at one edge of the hand-saw-blade other than the first edge. Instead of the handle the hand-saw may have a bow-shaped metal-frame, wherein ends of the bow-shaped metal-frame are attached to opposing edges of the hand-saw-blade different from the first edge.

According to an embodiment, a method of manufacturing a hand-saw-blade comprises the steps of providing a piece of metal or ceramics in at least one of an oblong, wedge or trapezoid shape, cutting saw teeth along a first edge of the piece of metal or ceramics, and cutting a plurality of elongated apertures spaced apart in a direction of the first edge into the piece of metal or ceramics, wherein a direction of elongation of the elongated apertures is oriented including an angle of between 15° and 65° and especially between 20° and 55° and further especially between 25° and 45° relative to the first edge. The steps of cutting the saw teeth and cutting the elongated apertures can be performed in any order or even at the same time.

According to an embodiment, the elongated apertures are cut by laser cutting and/or the teeth are cut by grinding or filing.

It is pointed out that the terms “comprising”, “having”, “containing”, “including” and “with” as well as their grammatic permutations generally have to be understood as non-concluding enumeration of features, such as for example method steps, elements, regions, variables and the like and in no way exclude the presence of other or additional features or groupings of other or additional features.

### BRIEF DESCRIPTION OF THE DRAWINGS

The forgoing as well as other advantageous features of the invention will be more apparent from the following detailed description of exemplary embodiments of the invention with reference to the accompanying drawings. It is noted that not all possible embodiments of the present invention necessarily exhibit each and every, or any, of the advantages identified herein.

It is pointed out that the invention is not restricted to the embodiments of the described exemplary embodiments, but is defined by the scope of the enclosed patent claims. In particular, the individual features including embodiments according to the invention can be realized in another quantity and combination than with the examples mentioned below. With the following explanation of some exemplary embodiments of the invention, reference is made to the enclosed Figures, of which

FIG. 1 is a schematic side-view of a hand-saw-blade according to an embodiment of the invention;

FIG. 2 is a schematic side-view of a handsaw having a hand-saw-blade according to an embodiment of the invention;

FIG. 3 is a schematic side-view of a backsaw having a hand-saw-blade according to an embodiment of the invention; and

FIG. 4 is a schematic side-view of a bow saw having a hand-saw-blade according to an embodiment of the invention.

### DETAILED DESCRIPTION OF EXEMPLARY EMBODIMENTS

In the exemplary embodiments described below, components that are alike in function and structure are designated as far as possible by alike reference numerals. Therefore, to understand the features of the individual components of a specific embodiment, the descriptions of other embodiments and of the summary of the invention should be referred to.

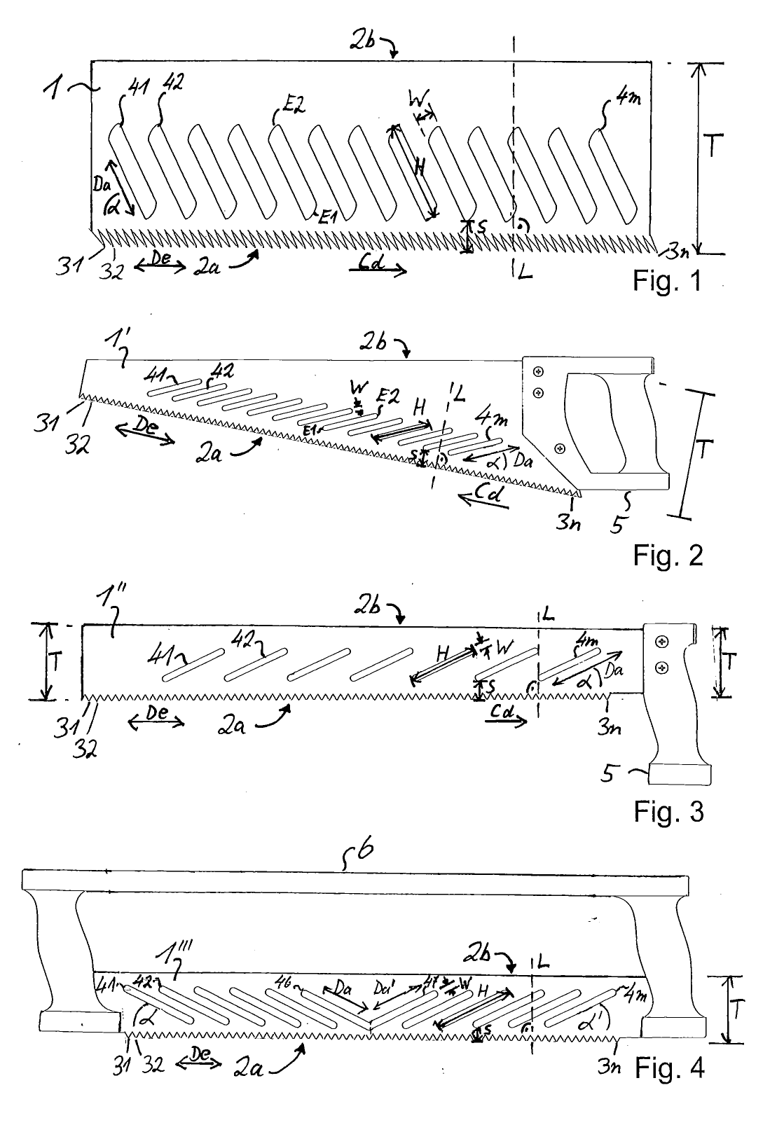

In the following, a hand-saw-blade (henceforth, ‘blade’) according to an embodiment is described with reference to FIG. 1. FIG. 1 is a schematic side view of the blade.

The blade 1 is made of a hard sheet of steel having a thickness of 2 mm (in the art also referred to as width). However, the present invention is neither restricted to the use of steel nor to a thickness of 2 mm. As alternatives, other metals such as copper or iron, or other materials such as ceramics may be used for the blade. Furthermore, the thickness may vary extensively; thicknesses of 0.1 mm to 5 mm are common and depend on the material to be cut.

A number of saw teeth 31, 32, . . . 3n (n being a natural number) are provided along a first edge 2a of the hand-saw-blade 1. In the present embodiment, the saw teeth 31, 32, . . . 3n are shaped such that the blade 1 has a cutting direction Cd along a direction De of the first edge 2a. The cutting effect of the blade 1 is greater when it is moved in the cutting direction Cd relative to a material to be cut (not shown) as compared to a cutting effect of the blade 1 when it is moved in a direction opposite to the cutting direction Cd, relative to a material to be cut. In FIG. 1, the saw teeth 31, 32, . . . 3n are of the cross-cut type. However, the present invention is not restricted to a certain type of saw teeth. Alternatively, saw teeth of a rip type can be used, for example. Furthermore, it is not necessary that the blade has a preferred cutting direction. In fact, the cutting effect may be the same in both directions along the direction De of the first edge 2a.

Thirteen elongated apertures 41, 42, . . . 4m (henceforth ‘apertures’) (m being a natural number) extending through the blade 1 in the thickness direction are provided spaced apart in the direction De of the first edge 2a. The apertures 41, 42, . . . 4m are oriented such that a direction Da of elongation of the apertures 41, 42, . . . 4m includes an angle α of 65°, relative to the first edge 2a. However, it is emphasised that the present invention is neither restricted to a certain number of apertures nor to an angle α of 65°. For the purposes of the present invention it is sufficient if more than two apertures are provided and if the angle α ranges from 15° to 65°. Provision of apertures having such an angle allows the removal of chips of cut material away from the first edge 2a. Furthermore, this orientation of the apertures 41, 42, . . . 4m causes additional pressure towards the material to be cut when the blade 1 is moved in the cutting direction Cd.

In the present example the length of the apertures 41, 42, . . . 4m is 22 mm. In the present embodiment, all apertures 41, 42, . . . 4m have the same size and shape and are equally spaced apart from each other. Although apertures having an oblong shape are shown in the figures, a variety of alternative shapes (e.g. arc shape) may be used.

As can be seen from FIG. 1, the apertures 41, 42, . . . 4m are arranged such that a line L, orthogonal to the first edge 2a intersects two of the apertures 41, 42, . . . 4m. However, the present invention is not restricted to such an intersection. Alternatively, the apertures 41, 42, . . . 4m may be arranged such that a line L orthogonal to the first edge 2a intersects only one aperture or more than two of the apertures.

As the direction Da of elongation of the apertures 41, 42, . . . 4m is inclined with respect to the first edge 2a, a first end E1 of the apertures 41, 42, . . . 4m located closer to the first edge 2a is displaced in the cutting direction Cd relative to a second end E2 of the same aperture 41, 42, . . . 4m. This second end E2 is located closer to a second edge 2b opposite to the first edge 2a of the blade 1.

In the embodiment shown in FIG. 1, a maximum distance S between the apertures 41, 42, . . . 4m and the outer end of the saw teeth 31, 32, . . . 3n on the first edge 2a measured orthogonal to the first edge 2a is 0.3-times the length H of the elongated apertures 41, 42, . . . 4m measured along the direction Da of elongation. When compared with the width W of the apertures 41, 42, . . . 4m measured in a direction orthogonal to the direction Da of elongation, the maximum distance S between the apertures 41, 42, . . . 4m and the outer end of the saw teeth 31, 32, . . . 3n on the first edge 2a of the blade 1 is two times the width W of the apertures 41, 42, . . . 4m. However, the present invention is not restricted to such values for the maximum distance S between the apertures 41, 42, . . . 4m and the outer end of the saw teeth 31, 32, . . . 3n on the first edge 2a measured orthogonal to the first edge 2a. It is usually sufficient that the maximum distance S is smaller than 0.5-times the length H of the apertures 41, 42, . . . 4m measured along the direction Da of elongation, but larger than 0.5-times the width W of the apertures 41, 42, . . . 4m measured in a direction orthogonal to the direction of elongation Da of the apertures 41, 42, . . . 4m. Such an arrangement of the apertures 41, 42, . . . 4m with respect to the first edge 2a guarantees that the apertures are located close enough to the first edge 2a having the saw teeth 31, 32, . . . 3n to efficiently remove chips of cut material, and also to maintain sufficient strength in the first edge 2a.

Furthermore, in the embodiment shown in FIG. 1, the length H of the apertures 41, 42, . . . 4m measured along the direction Da of elongation is 0.5-times a maximum distance T between the first and second edges 2a, 2b and thus 0.5-times a height of the blade 1. However, the present invention is not restricted to such values. It is usually sufficient that the length H of the apertures 41, 42, . . . 4m is greater than 0.1-times but smaller than 6-times this maximum distance T.

In the present embodiment, the width W of the apertures 41, 42, . . . 4m measured in a direction orthogonal to the direction Da of the apertures 41, 42, . . . 4m is 0.16-times the length of the apertures measured in the direction of elongation Da. As the width W in the present case is 4 mm, it is 2-times the thickness of the hand-saw-blade. However, the present invention is not restricted to such values. It is usually sufficient that the width W of the apertures 41, 42, . . . 4m is at least one of smaller than 0.5-times the length H of the apertures 41, 42, . . . 4m but larger than 0.05-times the length of the apertures 41, 42, . . . 4m, and smaller than 10-times but larger than 1-time the thickness of the blade 1.

With respect to the total surface of the blade 1 shown in FIG. 1, approximately 20% is covered by the apertures 41, 42, . . . 4m. However, the present invention is not restricted to such a value. It is usually sufficient that more than 1% but less than 60% of the total surface of a plane defined by the outer edges 2a, 2b of the blade 1 is covered by the apertures 41, 42, . . . 4m.

In the following different examples of hand-saws having a blade similar to the blade described above will be disclosed. To avoid unnecessary repetitions, reference is made to the embodiment shown in FIG. 1. Only differences will be discussed in more detail.

FIG. 2 shows a schematic side-view of a handsaw having a blade 1′.

This blade 1′ differs from the blade of FIG. 1 in that the overall shape of the blade 1 is that of a wedge. In FIG. 2, the material used for the blade 1′ is copper. A handle 5 is mounted to an edge of the blade 1 other than the first and second edges 2a, 2b.

Furthermore, the angle α included by a direction Da of elongation of the apertures 41, 42, . . . 4m and the first edge 2a having the saw teeth 31, 32, . . . 3n is only 25°.

A length H of the apertures 41, 42, . . . 4m measured in the direction Da of elongation is 82 mm and a width W measured in a direction orthogonal to the direction Da of elongation is 3 mm. Thus, the width W is 0.07-times the length H. In comparison to a maximum distance T between the first and second edges 2a, 2b, the length H of the apertures is 0.45-times this maximum distance T.

In the present embodiment, the saw teeth 31, 32, . . . 3n are shaped such that the blade 1 has a cutting direction Cd along a direction De of the first edge 2a. The cutting effect of the blade 1 is greater when it is moved in the cutting direction Cd relative to a material to be cut (not shown) as compared to a cutting effect of the blade 1 when it is moved in a direction opposite to the cutting direction Cd, relative to a material to be cut. Thus, in the embodiment of FIG. 2 the cutting effect of the blade 1 is most effective when the handle 5 is pushed in the direction of the blade 1.

A schematic side view of a back-saw is shown in FIG. 3.

A handle 5 is attached to an edge of the oblong blade 1″ orthogonal to the first and second edges 2a, 2b. In this embodiment, the blade 1″ consists of ceramics.

About 10% of the surface of this blade 1″ is covered by a total number of seven elongated apertures 41, 42, . . . 4m that are regularly spaced apart in a direction Da. The direction Da of elongation of these apertures 41, 42, . . . 4m and the first edge 2a include an angle α of 25°. A maximum distance S between the apertures 41, 42, . . . 4m and the outermost part of the saw teeth 31, 32, . . . 3n provided along the first edge 2a is 0.25-times the length H of the apertures 41, 42, . . . 4m measured along the direction Da of elongation of the apertures 41, 42, . . . 4m. In this embodiment, this distance S is 6 mm, the length H of the apertures 41, 42, . . . 4m is 34 mm and the width W of the apertures 41, 42, . . . 4m is 4 mm. As a maximum distance T between the first and second edges 2a, 2b of the blade is also 34 mm, the length of the apertures is about the same as this maximum distance T.

In FIG. 3, the blade 1″ has saw teeth 31, 32, . . . 3n that are shaped in an Asian style, thus having a cutting direction Cd towards the handle 5, whereas the hand saw of FIG. 2 has a cutting direction Cd which is in the opposite direction, i.e. orientated away from the handle 5. Thus, the saw of FIG. 2 is most effective when it is pushed, while the saw of FIG. 3 is most effective when it is pulled.

A side view of a hand-saw consisting of a blade 1′″ and a bow shaped metal frame 6 is shown in FIG. 4.

The ends of the bow shaped metal frame 6 are attached to opposite edges of the blade 1′″, different from the first and second edges 2a, 2b.

The saw teeth 31, 32, . . . 3n of the blade 1′″ shown in FIG. 4 are shaped in the rip cut and have no preferred cutting direction. Thus, the teeth 31, 32, . . . 3n are shaped in such a way that the cutting effect relative to a material to be cut is not dependent on the direction of movement along the first edge 2a.

Approximately 21% of the surface of the blade 1′″ are covered by apertures 41, 42, . . . 4m. A first group of elongated apertures 41, 42, . . . 46 are oriented in mirror inversion to a second group of elongated apertures 47, . . . 4m.

Due to the provision of the inclined elongated apertures in the above described saws, chips of cut material can be removed from the saw teeth of the blade. This increases the efficiency of sawing, as the chips are not worked several times. Moreover, friction between the blade and material being cut is lowered.

In the above Figures, for the sake of clear representation, only those elements, components and functions are shown which promote an understanding of the present invention. Embodiments of the invention however are not restricted to the elements, components and functions shown, but include further elements, components and functions insofar as these are required for their use or their scope of operation.

While the invention has been described with respect to certain exemplary embodiments thereof, it is evident that many alternatives, modifications and variations will be apparent to those skilled in the art. Accordingly, the exemplary embodiments of the invention set forth herein are intended to be illustrative and not limiting in any way. Various changes may be made without departing from the spirit and scope of the present invention as defined in the following claims.

What is claimed is:

1. A hand-saw-blade having:
a first edge provided with saw teeth; and
a plurality of elongated apertures spaced apart in a direction of the first edge;
wherein a direction of elongation of the elongated apertures is oriented including an angle of between 15° and 65° relative to the first edge.

2. The hand-saw-blade according to claim 1, wherein a maximum distance between the elongated apertures and the first edge measured orthogonal to the first edge is smaller than 0.5-times the length of the elongated apertures measured along the direction of elongation.

3. The hand-saw-blade according to claim 1, wherein a maximum distance between the elongated apertures and the first edge measured orthogonal to the first edge is larger than 0.5-times the width of the elongated apertures measured in a direction orthogonal to the direction of elongation of the elongated apertures.

4. The hand-saw-blade according to claim 1,
wherein the hand-saw-blade has a second edge located opposite to the first edge, and
wherein a length of the elongated apertures measured along the direction of elongation is greater than 0.1-times a maximum distance between the first and second edges.

5. The hand-saw-blade according to claim 1,
wherein the hand-saw-blade has a second edge located opposite to the first edge, and
wherein a length of the elongated apertures measured along the direction of elongation is smaller than 6-times a maximum distance between the first and second edges.

6. The hand-saw-blade according to claim 1, wherein a width of the elongated apertures measured in a direction orthogonal to the direction of elongation of the elongated apertures is smaller than 0.5-times the length of the elongated apertures measured along the direction of elongation or a width of the elongated apertures measured in a direction orthogonal to the direction of elongation of the elongated apertures is smaller than 10-times the thickness of the hand-saw-blade.

7. The hand-saw-blade according to claim 1, wherein a width of the elongated apertures measured in a direction orthogonal to the direction of elongation of the elongated apertures is larger than 0.05-times the length of the elongated apertures measured along the direction of elongation or a width of the elongated apertures measured in a direction orthogonal to the direction of elongation of the elongated apertures is larger than 1-time the thickness of the hand-saw-blade.

8. The hand-saw-blade according to claim 1, wherein the elongated apertures cover more than 1% of a total surface of a plane defined by outer edges of the hand-saw-blade.

9. The hand-saw-blade according to claim 1, wherein the elongated apertures cover less than 60% of a total surface of a plane defined by outer edges of the hand-saw-blade.

10. The hand-saw-blade according to claim 1, wherein a length of the elongated apertures measured along the direction of elongation is greater than 5 mm or a width of the elongated apertures measured in a direction orthogonal to the direction of elongation of the elongated apertures is between 15 mm and 1 mm.

11. The hand-saw-blade according to claim 1, wherein more than 5 elongated apertures are spaced apart in a direction of the first edge.

12. The hand-saw-blade according to claim 1, wherein the elongated apertures have an oblong or curved shape.

13. The hand-saw-blade according to claim 1, further comprising a handle or a bow-shaped metal-frame,
wherein the handle is mounted at one edge of the hand-saw-blade other than the first edge respectively ends of the bow-shaped metal-frame are attached to opposing edges of the hand-saw-blade different from the first edge.

14. The hand-saw-blade according to claim 1, wherein a line orthogonal to the first edge intersects two or more elongated apertures.

15. The hand-saw-blade according to claim 2,
wherein the hand-saw-blade has a cutting direction oriented along the direction of the first edge, wherein a cutting effect of the hand-saw-blade is greater when it is moved in the cutting direction relative to a material to be cut as compared to a cutting effect of the hand-saw-blade when it is moved in a direction opposite to the cutting direction relative to the material to be cut, and
wherein a first end of the elongated aperture located closer to the first edge is displaced in the cutting direction relative to a second end of the elongated aperture located closer to a second edge located opposite to the first edge.

16. The hand-saw-blade according to claim 15, wherein a maximum distance between the elongated apertures and the first edge measured orthogonal to the first edge is smaller than 0.5-times the length of the elongated apertures measured along the direction of elongation.

17. The hand-saw-blade according to claim 15, wherein a maximum distance between the elongated apertures and the first edge measured orthogonal to the first edge is larger than 0.5-times the width of the elongated apertures measured in a direction orthogonal to the direction of elongation of the elongated apertures.

18. The hand-saw-blade according to claim 15,
wherein the hand-saw-blade has a second edge located opposite to the first edge, and
wherein a length of the elongated apertures measured along the direction of elongation is greater than 0.1-times a maximum distance between the first and second edges.

19. The hand-saw-blade according to claim 15,
wherein the hand-saw-blade has a second edge located opposite to the first edge, and
wherein a length of the elongated apertures measured along the direction of elongation is smaller than 6-times a maximum distance between the first and second edges.

20. The hand-saw-blade according to claim 15, wherein a width of the elongated apertures measured in a direction orthogonal to the direction of elongation of the elongated apertures is smaller than 0.5-times the length of the elongated apertures measured along the direction of elongation or a width of the elongated apertures measured in a direction orthogonal to the direction of elongation of the elongated apertures is smaller than 10-times the thickness of the hand-saw-blade.

21. The hand-saw-blade according to claim 15, wherein a width of the elongated apertures measured in a direction orthogonal to the direction of elongation of the elongated apertures is larger than 0.05-times the length of the elongated apertures measured along the direction of elongation or a width of the elongated apertures measured in a direction orthogonal to the direction of elongation of the elongated apertures is larger than 1-time the thickness of the hand-saw-blade.

22. The hand-saw-blade according to claim 15, wherein the elongated apertures cover more than 1% of a total surface of a plane defined by outer edges of the hand-saw-blade.

23. The hand-saw-blade according to claim 15, wherein the elongated apertures cover less than 60% of a total surface of a plane defined by outer edges of the hand-saw-blade.

24. The hand-saw-blade according to claim 15, wherein a length of the elongated apertures measured along the direction of elongation is greater than 5 mm or a width of the elongated apertures measured in a direction orthogonal to the direction of elongation of the elongated apertures is between 15 mm and 1 mm.

25. The hand-saw-blade according to claim 15, wherein more than 5 elongated apertures are spaced apart in a direction of the first edge.

26. The hand-saw-blade according to claim 15, wherein the elongated apertures have an oblong or curved shape.

27. The hand-saw-blade according to claim 15 further comprising a handle or a bow-shaped metal-frame,
wherein the handle is mounted at one edge of the hand-saw-blade other than the first edge respectively ends of the bow-shaped metal-frame are attached to opposing edges of the hand-saw-blade different from the first edge.

28. The hand-saw-blade according to claim 1,
wherein the hand-saw-blade has a cutting direction oriented along the direction of the first edge, wherein a cutting effect of the hand-saw-blade is greater when it is moved in the cutting direction relative to a material to be cut as compared to a cutting effect of the hand-saw-blade when it is moved in a direction opposite to the cutting direction relative to the material to be cut, and
wherein a first end of the elongated aperture located closer to the first edge is displaced in the cutting direction relative to a second end of the elongated aperture located closer to a second edge located opposite to the first edge.

29. The hand-saw-blade according to claim 28, wherein a maximum distance between the elongated apertures and the first edge measured orthogonal to the first edge is smaller than 0.5-times the length of the elongated apertures measured along the direction of elongation.

30. The hand-saw-blade according to claim 28, wherein a maximum distance between the elongated apertures and the first edge measured orthogonal to the first edge is larger than 0.5-times the width of the elongated apertures measured in a direction orthogonal to the direction of elongation of the elongated apertures.

31. The hand-saw-blade according to claim 28,
wherein the hand-saw-blade has a second edge located opposite to the first edge, and
wherein a length of the elongated apertures measured along the direction of elongation is greater than 0.1-times a maximum distance between the first and second edges.

32. The hand-saw-blade according to claim 28,
wherein the hand-saw-blade has a second edge located opposite to the first edge, and
wherein a length of the elongated apertures measured along the direction of elongation is smaller than 6-times a maximum distance between the first and second edges.

33. The hand-saw-blade according to claim 28, wherein a width of the elongated apertures measured in a direction orthogonal to the direction of elongation of the elongated apertures is smaller than 0.5-times the length of the elongated apertures measured along the direction of elongation or a width of the elongated apertures measured in a direction orthogonal to the direction of elongation of the elongated apertures is smaller than 10-times the thickness of the hand-saw-blade.

34. The hand-saw-blade according to claim 28, wherein a width of the elongated apertures measured in a direction orthogonal to the direction of elongation of the elongated apertures is larger than 0.05-times the length of the elongated apertures measured along the direction of elongation or a width of the elongated apertures measured in a direction orthogonal to the direction of elongation of the elongated apertures is larger than 1-times the thickness of the hand-saw-blade.

35. The hand-saw-blade according to claim 28, wherein the elongated apertures cover more than 1% of a total surface of a plane defined by outer edges of the hand-saw-blade.

36. The hand-saw-blade according to claim 28, wherein the elongated apertures cover less than 60% of a total surface of a plane defined by outer edges of the hand-saw-blade.

37. The hand-saw-blade according to claim 28, wherein a length of the elongated apertures measured along the direction of elongation is greater than 5 mm or a width of the elongated apertures measured in a direction orthogonal to the direction of elongation of the elongated apertures is between 15 mm and 1 mm.

38. The hand-saw-blade according to claim 28, wherein more than 5 elongated apertures are spaced apart in a direction of the first edge.

39. The hand-saw-blade according to claim 28, wherein the elongated apertures have an oblong or curved shape.

40. The hand-saw-blade according to claim 28, further comprising a handle or a bow-shaped metal-frame,
wherein the handle is mounted at one edge of the hand-saw-blade other than the first edge respectively ends of the bow-shaped metal-frame are attached to opposing edges of the hand-saw-blade different from the first edge.
